(19) United States
(12) Patent Application Publication
(10) Pub. No.: US 2008/0133325 A1
(43) Pub. Date: Jun. 5, 2008

(54) Systems And Methods For Segment-Based Payment Card Solutions

(76) Inventors: Sruba De, Houston, TX (US); Anant Nambiar, Larchmont, NY (US); Sheryl Sleeva, Norwalk, CT (US)

Correspondence Address: BAKER BOTTS L.L.P., 30 ROCKEFELLER PLAZA, 44TH FLOOR, NEW YORK, NY, 10112-4498, US

(21) Appl. No.: 11/755,288

(22) Filed: May 30, 2007

Related U.S. Application Data
(60) Provisional application No. 60/809,236, filed on May 30, 2006.

(51) Int. Cl. G06Q 10/00

(52) U.S. Cl. 705/10; 705/7

(57) ABSTRACT

A payment card product targeted to specific consumer market segments is provided. The payment card product has features, benefits and functions that are responsive to consumer needs, aspirations and habits, which evolve over time and across consumer market segments. The consumer market segments are comprehensively characterized using a combination of demographic, attitudinal and behavioral analyses and research. Consumer ideation processes used in product design ensure that the card features, benefits and functions are relevant to consumers. Quantitative methods are used to optimize the product design with respect to consumer market segment characteristics.

### CROSS-REFERENCE TO RELATED APPLICATION

This application claims the benefit of U.S. provisional patent application No. 60/809,236, filed on May 30, 2006, which is hereby incorporated by reference herein in its entirety.

### BACKGROUND OF THE INVENTION

The introduction and popularization of payment cards (e.g., credit cards, ATM and debit cards, charge cards etc.) has been one of the most significant changes in the way people can pay for goods and services in the modern economy. Payment-by-card transactions are often more convenient and more secure than paper-based payment processes.

The global market for payment cards is growing as the economy shifts away from paper-based payment processes. Banks and other financial institutions (“card companies” or “issuers”) compete to provide payment cards to consumers (“cardholders”). Card companies may offer incentives or otherwise tailor their card products to differentiate their card products in the marketplace. For example, payment cards are often associated with incentives (e.g., rebates, frequent flier miles, additional warranty coverage for items purchased, car rental insurance, travel accident insurance or travel-related discounts, etc.) that are targeted to appeal to particular groups or populations of cardholders. Consumers can be segmented or targeted based on a variety of factors including age, gender, location, geographic factors, demographic characteristics, family life cycle, lifestyle, desire for relaxation, or time pressures. Different payment card products may be narrowly designed and marketed to serve the needs or desires of specific market segments or cardholder populations (e.g., different customer age groups). FIG. 1A shows exemplary market segments to which traditional card products are directed or positioned. FIG. 1B outlines a traditional approach for bringing a card product to a market segment. First, a potential market segment is identified and analyzed. One or more trial product cards are designed with features to meet the target market segment characteristics. The trial product cards are tested for suitability, for example, using focus groups. A suitable product card is then selected and rolled out.

The narrow design and segment-by-segment targeting of payment card products by card companies may be advantageous for market penetration and/or coverage. However, there is the risk of the market going sour or a competitor entering the same market segment. Further, the same narrow design and segment-by-segment targeting disadvantageously decreases product longevity and cardholder retention. As cardholder needs evolve or change, cardholders readily add or switch change payment cards and card companies leading to the current situation where the average US consumer carries more that five credit cards. Relentless competition, challenging market dynamics and changing cardholder behavior force the need for perpetual differentiation. Card companies devote considerable effort to profiling cardholders, so as to be responsive to their changing needs.

For example, assignee MasterCard International Incorporated (“MasterCard”) has developed systems and methods for real-time transaction-based cardholder profiling. (See e.g., MasterCard's co-pending U.S. patent application Ser. No. 10/800,875, filed Mar. 15, 2004, which is hereby incorporated by reference in its entirety herein). Such real-time transaction-based profiling systems and methods are designed to make a rolling profile summary of each cardholder's behavior available for immediate analysis. A rolling profile summary may contain timely information such as “three purchases were made within one month from vendors within the ‘jewelry and giftware’ category”, “the average purchase amount for this cardholder is $52”, “this cardholder is interested in sports,” etc. The rolling profile summary also may contain up-to-date estimates of home ZIP code, age, gender, income, and other demographic information. Such real-time transaction-based profiling can be used by MasterCard as a means to monitor a cardholder's purchasing activities to detect events such as moving, pregnancy, and college graduation in the cardholder's life.

Consideration is now being given to ways of improving payment card products. Attention is being directed to improving payment card products with a view to increase both product longevity and customer retention. In particular, attention is being directed to developing payment card products having more relevant, flexible features that address not only a consumers' financial needs, but also other needs they may have related to their lifestage, lifestyle, etc. Desirable payment card products will have features that can accommodate evolving cardholder needs across market segments, and thereby discourage cardholders from switching card products.

### SUMMARY OF THE INVENTION

Payment card products having features that can accommodate evolving cardholder needs across market segments, and methods for making such products are provided.

The payment card products are developed by first defining target market segments and conducting comprehensive characterization and opportunity analysis of the market segments. The payment card products' features are designed to address consumer needs and challenges beyond just payment. These needs are identified by considering the consumers' attitudinal and psychographic behaviors in addition to traditional consideration of their payment card transaction behavior or habits. Consumer ideation sessions are used to involve the consumers themselves in product design. This can ensure that the card features included in product cards are truly responsive to consumer needs.

Further features of the invention, its nature and various advantages will be more apparent from the accompanying drawings and the following detailed description.

### BRIEF DESCRIPTION OF THE DRAWINGS

FIG. 1A is a schematic diagram illustrating exemplary market segments to which traditional payment card products are directed or positioned.

FIG. 1B is a schematic flow diagram illustrating a traditional product development approach for bringing a segment-based payment card product to market.

FIG. 1C is a schematic flow diagram illustrating a product development approach for bringing a payment card product to market, in accordance with the principles of the present invention.

FIG. 2 is a schematic diagram illustrating card elements, which may be packaged in a particular payment card product by a card association, in accordance with the principles of the present invention.

FIG. 3 is a schematic diagram illustrating card elements, which may be packaged in a particular payment card product by a financial institution issuer, in accordance with the principles of the present invention.

FIG. 4 is a schematic diagram illustrating a customized payment card product having card elements selected by a card association and card elements selected by a financial institution issuer, in accordance with the principles of the present invention.

FIG. 5 is a chart illustrating exemplary life cycle stages and profiles.

FIG. 6 is a schematic illustration of the combined use of demographic, attitudinal and behavioral analyses for comprehensive characterization of consumer needs, in accordance with the principles of the present invention.

FIG. 7 is a schematic illustration of the exemplary steps in a market analysis process used for developing a new card product based on multidimensional segment analysis, in accordance with the principles of the present invention.

FIG. 8 is a schematic illustration of the identification of an opportunity segment using demographic analysis, in accordance with the principles of the present invention.

FIG. 9 is an illustration of a detailed profile of representative persona (“Jane”) of a targeted market segment obtained by the combined use of demographic, attitudinal and behavioral analyses, in accordance with the principles of the present invention.

FIG. 10 is an illustration summarizing key characteristics of a market segment that are determined to be relevant to product card development using the analysis of FIG. 7, in accordance with the principles of the present invention.

FIG. 11 is a schematic illustration of the steps in an exemplary quantitative research process for optimizing features of a card product to attract the most target consumers, in accordance with the principles of the present invention.

### DETAILED DESCRIPTION OF THE INVENTION

Payment card products having flexible features, benefits and other functions to accommodate cardholder needs across market segments are provided. Further, methods for making the card features responsive to evolving cardholder needs are provided. For convenience in description herein, the inventive products and methods are referred to collectively as “payment card solutions.” The inventive payment card solutions take into account the characteristics and requirements of all entities (e.g., card associations, issuers, acquirers, merchants and cardholders) that are involved in payment-by-card transaction systems.

The inventive payment card solutions leverage demographic market segment analysis, which is used for traditional card products to create sets of features, benefits and functions (hereinafter, “card elements”). The card elements may include elements that are implemented or controlled by different entities involved in bringing the payment card to market and its operation (e.g., card association MasterCard, financial institution issuer, etc.).

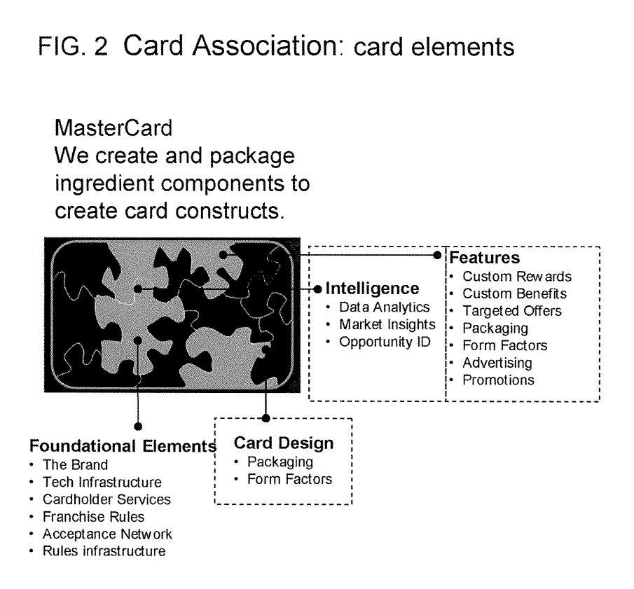

With reference to FIG. 2, the card elements that are implemented by card associations may include foundational elements (e.g., Brand, Tech Infrastructure, Cardholder Services, Franchise Rules, Acceptance Network, Rules Infrastructure, etc.), card design elements (e.g., Packaging, and Form Factors), intelligence elements (e.g., Data Analytics, Market Insights, Opportunity ID, etc.), feature elements (e.g., Custom Rewards, Custom Benefits, Targeted Offers, Packaging, Form Factors, Advertising, Promotions, etc.), and other elements.

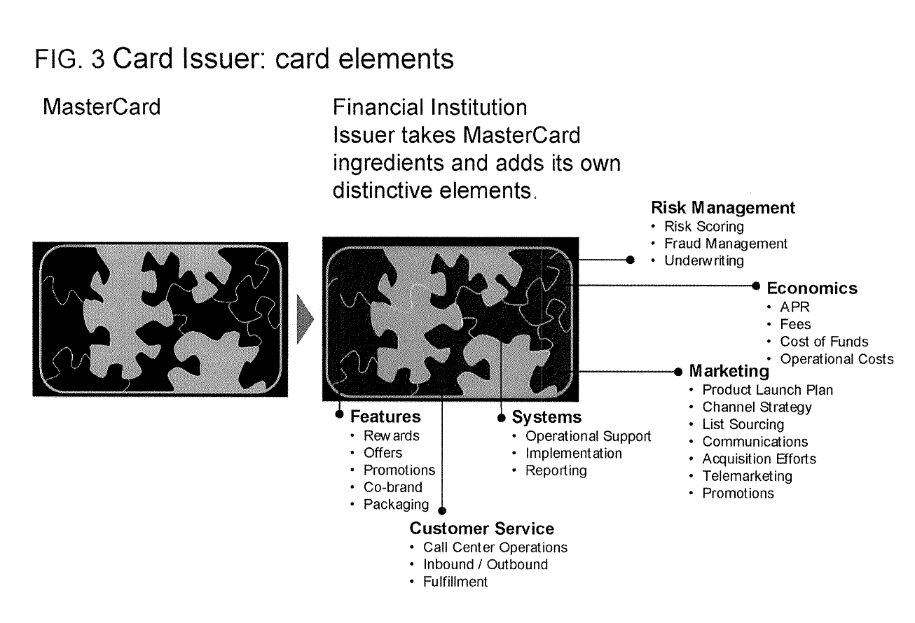

With reference to FIG. 3, the card elements that are implemented by the financial institution issuer may include card feature elements (e.g., Rewards, Offers, Promotions, Co-brand, Packaging, etc.), customer service elements (e.g., Call Center Operations, Inbound/Outbound, Fulfillment, etc.), systems elements (e.g., Operational Support, Implementation, Reporting, etc.), risk management elements (e.g., Risk Scoring, Fraud Management, Underwriting, etc.), economic elements (e.g., APR, Fees, Cost of Funds, Operational Costs, etc.), marketing elements (e.g., Product Launch Plan, Channel Strategy, List Sourcing, Communications, Acquisition Efforts, Telemarketing, Promotions, etc.), and other elements.

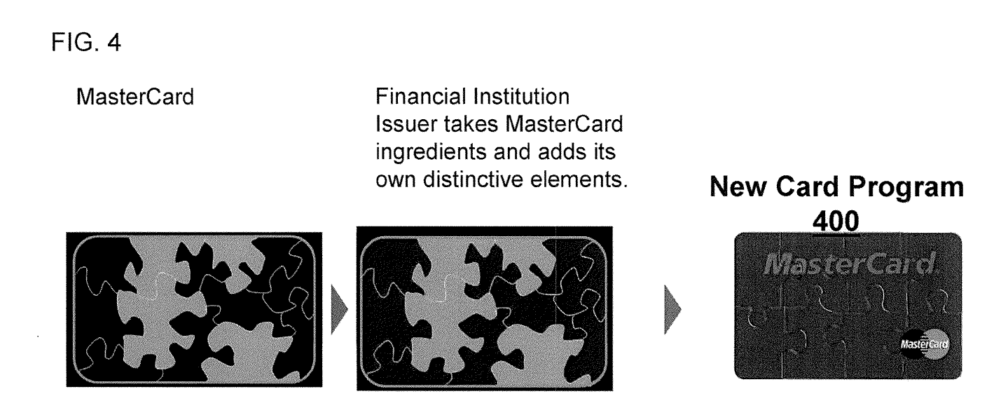

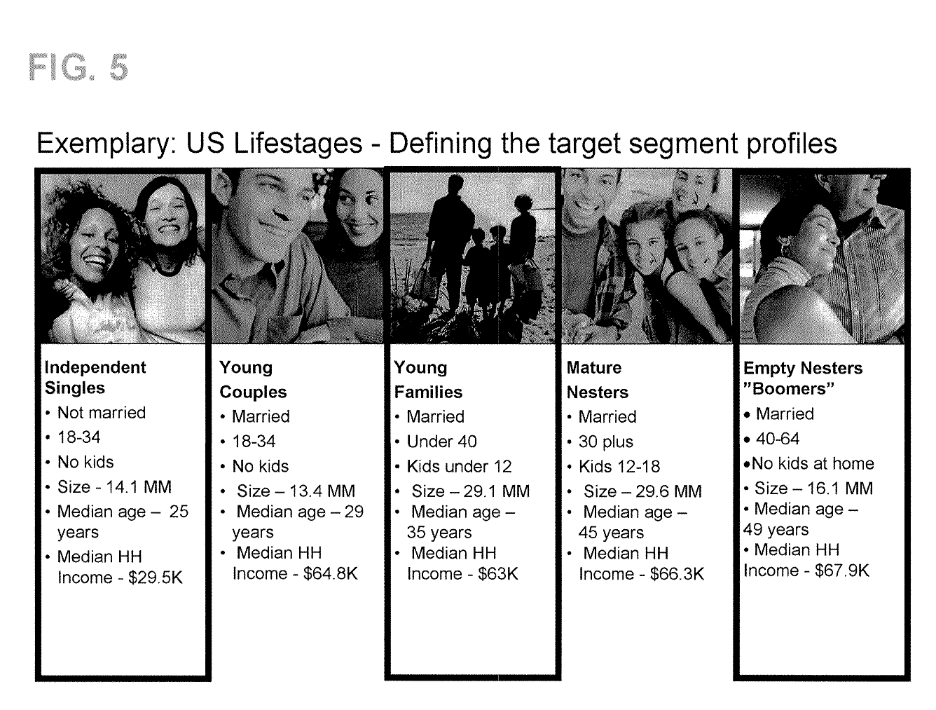

Card elements that will be relevant to cardholders over time are identified to further cardholder loyalty and growth. Select card element packages or bundles are associated with product payment cards so that the product cards can satisfy cardholder needs and desires across market segments and over time. A selected package or bundle of card elements for a particular product card construct 400 may include elements that are controlled or implemented by the card association and other elements that are controlled or implemented by the financial institution issuer. (See FIG. 4).

According to the inventive payment card solutions, market segments are identified and comprehensively characterized using a combination of demographic, attitudinal and behavioral analyses. The comprehensive characterization of market segments allows purposeful selection of card elements to design product cards with desirable properties (e.g., longevity, customer retention across market segments, etc.).

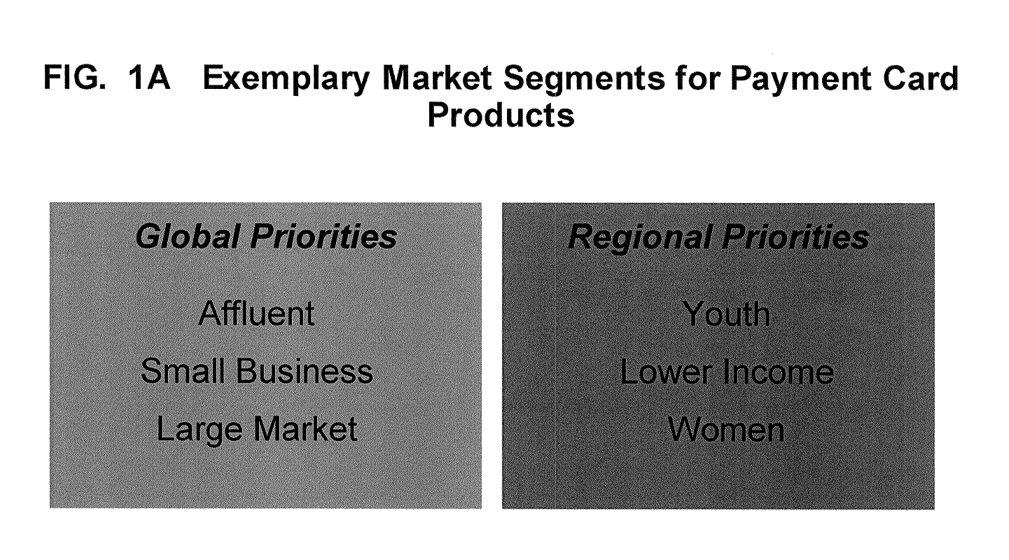

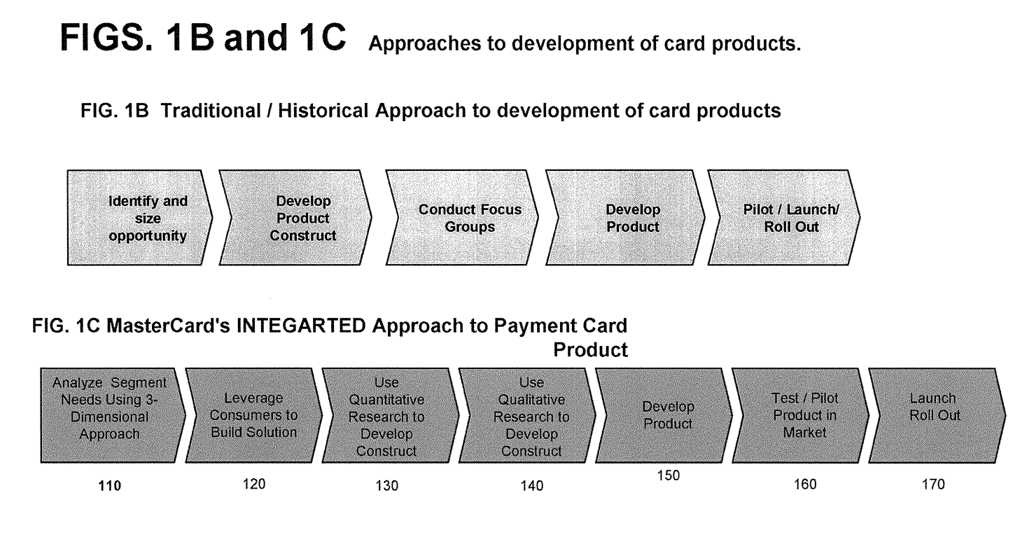

FIG. 1C shows the exemplary processes 110-160 involved in bringing a product card to market, according to the inventive payment card solutions. In market analysis process 110, market segments are identified and comprehensively characterized. Optional consumer leveraging process 120 involves consumer ideation to build, enhance, or confirm purposeful card element selections. Processes 130 and 140 involve quantitative and qualitative research for the development of a card construct (i.e., for purposeful card element selections). The subsequent product development, test/piloting and launch/roll out processes 150-170 may be conventional. However, results of processes 150-170 can be used as feedback to processes 110-140 to further refine payment card constructs.

An implementation of the inventive payment card solutions is described herein using, for purposes of illustration only, an exemplary market segmentation by family life cycle stages (“Life stages”). However, it will be understood that the invention is not limited to the exemplary life stages market segmentation, but is applicable to all types of market segmentation.

Life stages market segmentation recognizes that certain demographic attributes help marketers understand consumer behavior. The influence of attributes—age, the presence of children living at home, and income, is believed to be especially relevant in terms of how consumers spend money and free time. Life stages segmentation provides intuitive segments, which are easy to understand and describe. For example, most people will readily know what is meant by describing a segment as “Upper-Income Mature Nesters.” (See e.g., FIG. 5). Life stages market segmentation is well understood and commonly used by marketers to gain insights into the evolution of customer needs over time. For example, life stages market segmentation is widely used in the financial services industry for positioning products in the marketplace. The theory behind this type of marketing is that certain events or moments in people's lives trigger particular needs or desires. Life stage marketing is about marketing specific products to customers to match their particular needs or desires in a way that is dependent on their present life stage.

The inventive payment card solutions are based on comprehensive insights into cardholder behavior generated by multidimensional analysis, which goes beyond the traditional life cycle analysis of customer or cardholder behavior. The comprehensive insights can be used to create card features or elements that are both emotionally and functionally relevant to a particular cardholder. It is recognized that card issuers have traditionally relied heavily on demographic approaches (e.g., life stages analysis looking at age and income individually). Demographics play a critical role in sizing opportunities, driving business cases and profitability analyses. However, social shifts have changed the power of demographics as a predictor of consumer preferences. Demographics cannot be solely relied upon to obtain comprehensive insights into consumer behavior in dynamic marketplaces. Demography-based analyses operate at a very high level and do not provide insight into what motivates consumers.

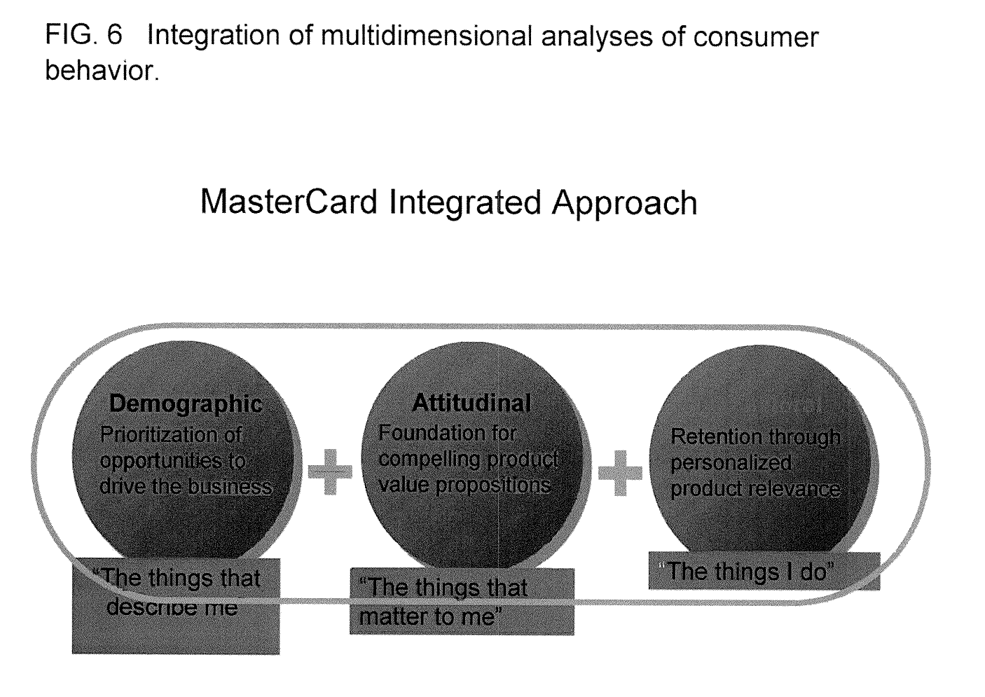

In a particular implementation of a payment card solution (hereinafter, “MasterCard LifeSights Approach”) comprehensive insights into consumer behavior are obtained by combining attitudinal and behavioral analysis with traditional life stages analysis. (See FIG. 6).

The combined analyses advantageously can lead to identification and creation of new perceptions of value, sources of differentiation and new opportunities for business growth for payment card products and programs. The combined analyses provide more specific and relevant insights that are suitable for product development initiatives than demographic or any individual analysis type, for example, attitudinal or behavioral, alone can provide.

Attitudinal analysis provides market insights into consumer psychographics, which are a powerful platform for creating products that build consumer involvement. Attitudinal perspectives change over time, and thus these insights have the potential to maximize lifetime value to individual consumers. Consumer attitudes can inform both the functional and emotional elements of a payment card product to create a high degree of relevance to individual consumers. Attitudinal analysis is a powerful means of creating product value based on the psychographic drivers that are most important to the consumer. In order to develop products that appeal to consumers on an emotional level, attitudinal analysis provides an understanding of consumer motivations and priorities by identifying what is most relevant to them. However, “targetability” based on attitudes alone can be difficult and challenging. Fortunately, target ability can be addressed by demographic analysis. Further, attitudes are typically aspirational, and not practiced behaviors or habits. The latter can be addressed by behavioral analysis.

Behavioral analysis can strengthen customer experience and retention. Behavioral analysis is an extremely powerful means of accurately predicting consumer needs and preferences based on their past transactions. Internet sites (and specifically e-commerce) now commonly establish consumer expectations and comfort levels by predictive modeling of consumer behavior. For example, news and portal sites are now customized based on browsing history; e-commerce vendors (e.g., Amazon.com) provide personalized content based on buying history; and banking sites are now personalized based on most common transactions. Similarly, behavioral analysis allows card products and offers to evolve in step with consumer expectations. In particular, behavioral analysis provides tools for enabling card product personalization. However, behavioral analysis alone cannot provide insights into consumer attitudes or motivations that are useful for crafting value propositions for new card products. With reference to market analysis process 110 (FIG. 1C), the MasterCard Integrated Approach combines and exploits the best of the three analyses for the development of optimal payment card products and programs. Demographic analysis allows prioritization of opportunities to drive the business. Attitudinal analysis provides the foundation for compelling product value propositions. Behavioral analysis encourages cardholder retention through personalized product relevance.

The MasterCard Integrated Approach advantageously drives card product innovation during the development of card products, and not merely marketing or advertising communications about card products. Identification of the drivers of emotional relevance in the MasterCard Integrated Approach analyses can lead to card products having emotionally relevant product features, which, further, can change with an individual cardholder's specific needs. Additionally, the MasterCard Integrated Approach advantageously provides a foundation for product personalization in the development of card products, which can be the basis of mass or wide spread personalization of card products and features. The MasterCard LifeSights Approach also advantageously identifies marketing opportunities for non-card products. For example, the comprehensive insights into consumer attitudes and preferences gained in card product development can be exploited for the marketing and cross-selling of both financial and non-financial products.

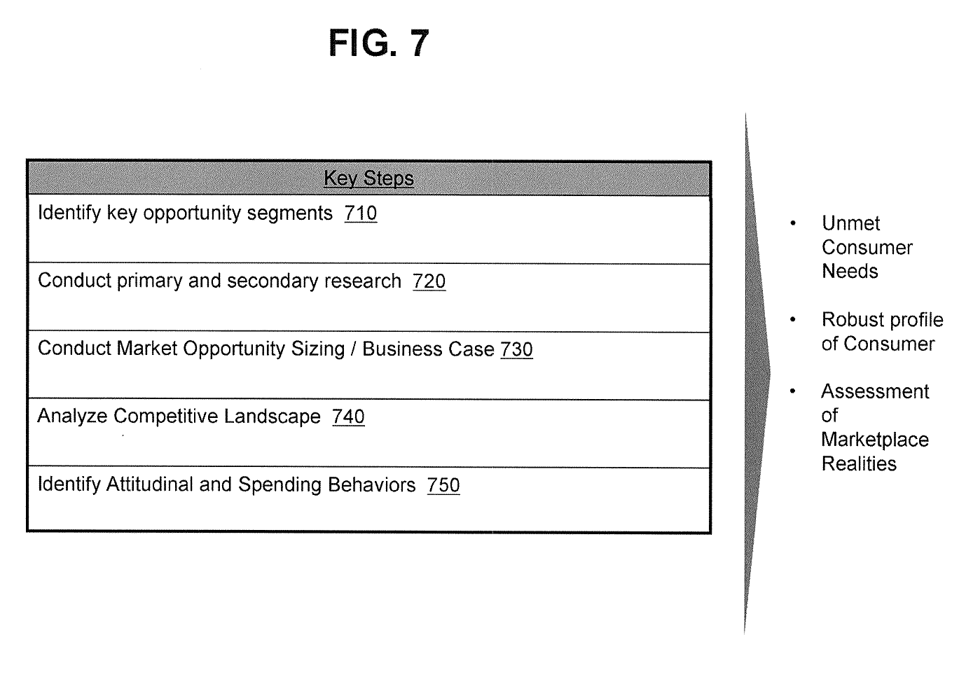

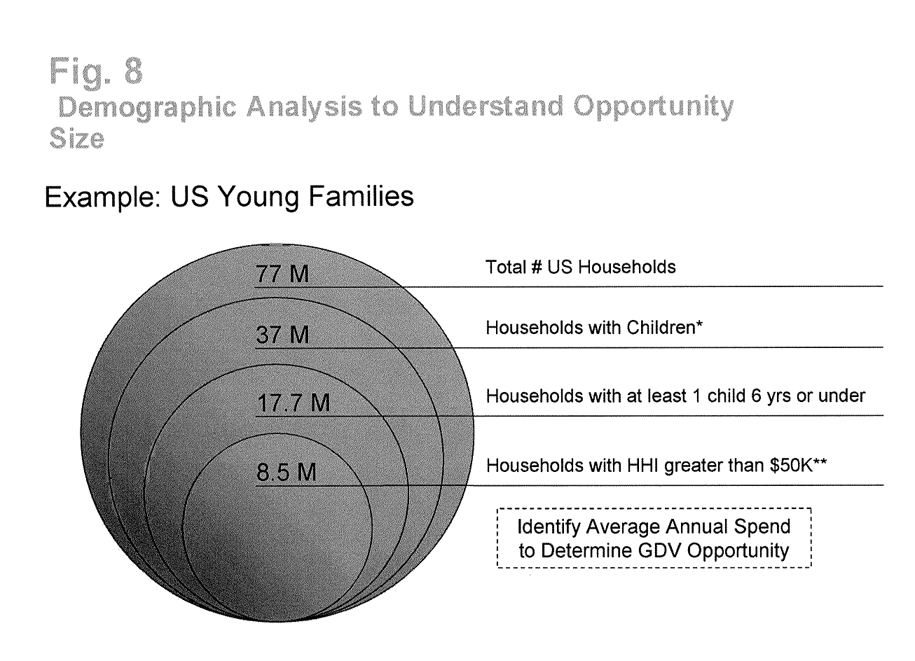

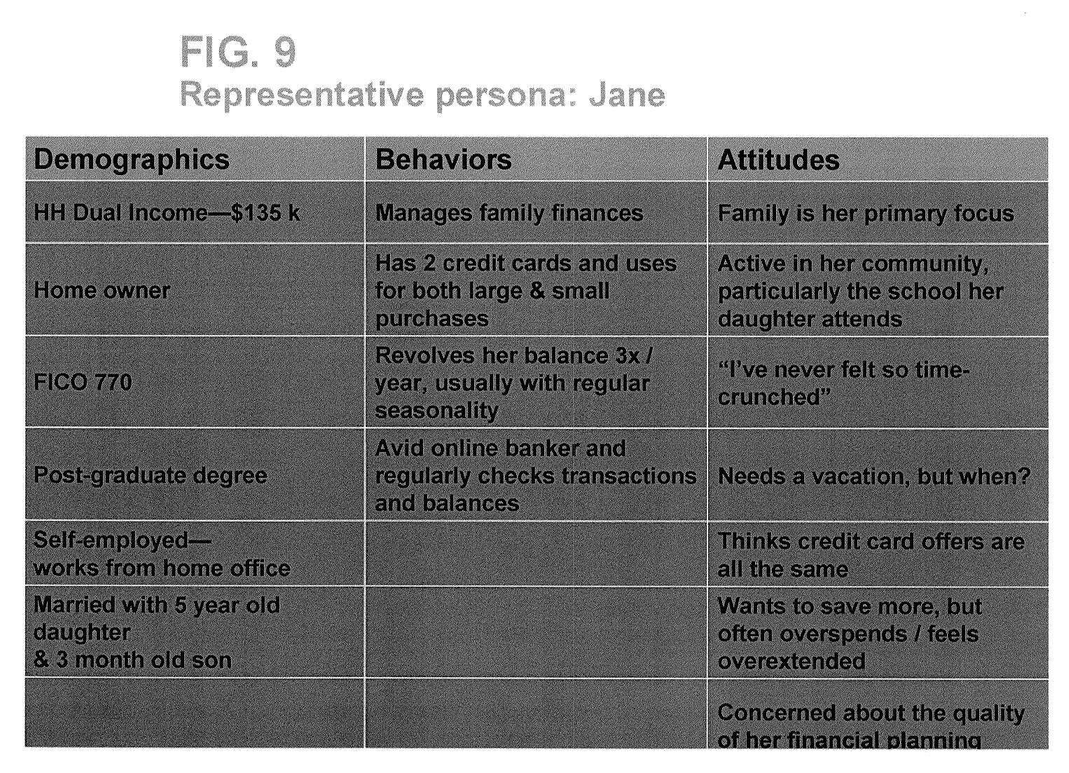

FIG. 7 shows exemplary steps in market analysis process 110 (FIG. 1C) that may be used in the MasterCard Approach for developing a new card product based on multidimensional segment analysis, e.g., demographic, attitudinal, and behavioral analysis. The multidimensional segment analysis is used to inform product design. At step 710, key opportunity segments are identified using, for example, demographic analysis. FIG. 8 shows, for example, identification of an opportunity segment using demographic analysis. In particular, FIG. 8 shows the identification of the market segment—Young Families in the U.S. having household incomes (HHI) greater that $50,000 per annum, as an opportunity segment.

With renewed reference to FIG. 7, at step 720, primary and secondary market research is conducted. At step 730, market opportunity sizing is undertaken and a business case is made. At step 740, the competitive landscape is surveyed and analyzed. At step 750, consumer attitudes and behaviors are identified. The results of steps 710-750 include robust consumer profiles, identification of unmet consumer needs, and an assessment of marketplace realities.

For example, at step 750, attitudinal analysis may indicate that parents of children under the age of five (“Young Families”) regardless of age and income share the most commonality within a life stage compared to other life stages. Further, Young Families are willing to switch credit card brands, express a desire to get credit card products that better meet their needs, do not have rigid conceptions of payment card brands, are open to new alternatives in credit card products, and increasingly choose debit card products over credit cards because of fear of overspending and need for control.

Card usage behavior analysis, based on panel results, may provide insight, for example, that MasterCards are present in affluent Young Families' wallets at higher rates than for general population; that 68% of the target segment carry MasterCard vs. 56% of general population; that MasterCard is at the top of the affluent Young Families' wallets; that 34% of affluent Young Families use MasterCard as their primary card—higher than Visa or AMEX; and that MasterCard has a 9 year history of effective advertising/marketing campaigns communicating the MasterCard brand identity to affluent Young Families and addressing their needs.

Spending behavior analysis may be based on consumer panel research (e.g., MasterCards' payment panel of 22,000 U.S. households). Such analysis may provide insight, for example, that while Young Families increasingly use debit cards, a majority of affluent Young Families use credit cards, and therefore indicate that affluent Young Families are an attractive target segment for new credit card programs. For this affluent segment, 58% engage in more than 21 credit card transactions every month, and 53% revolve balances vs. 31% who have transactions.

Further, card usage behavior analysis may provide insight that Young Families allocate a higher proportion of transactions to mass merchandise/department stores, children's apparel, toy stores, tuition, sporting goods, home improvement, and family apparel. Similarly, card usage behavior analysis may indicate the top merchants where Young Families spend are Gymboree, Gap Kid, The Children's Place, Babies R Us, Gap, Target, Nordstrom, Old Navy, country clubs and airlines.

Competitive Assessment at step 750 may involve research into what card products are most prominent in Young Family wallets and identify an opportunity to develop a particularly targeted product (e.g., a co-branded product). For example, such research may provide insight that Costco Card and Disney co-brands are leading cards in Young Family wallets.

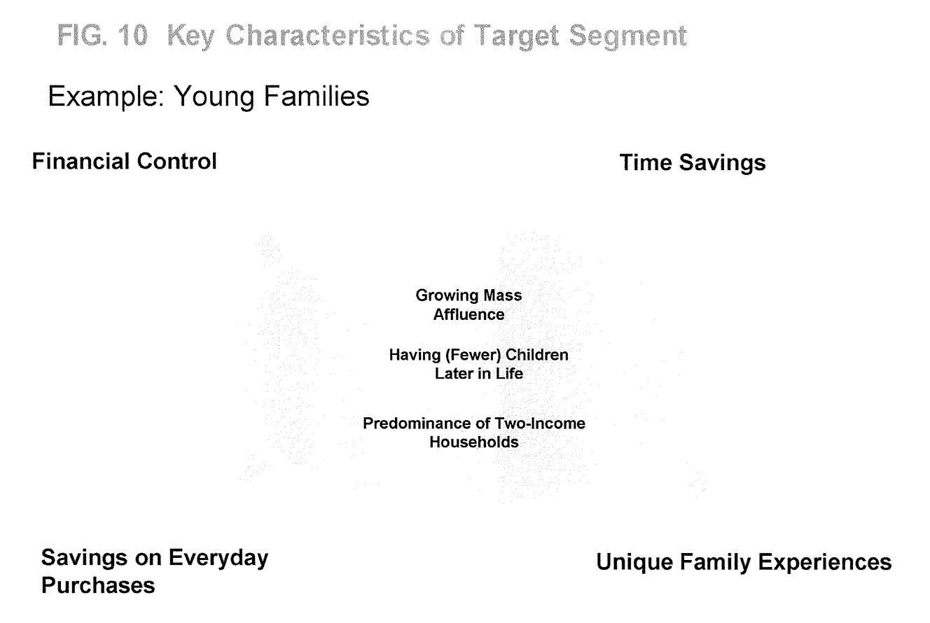

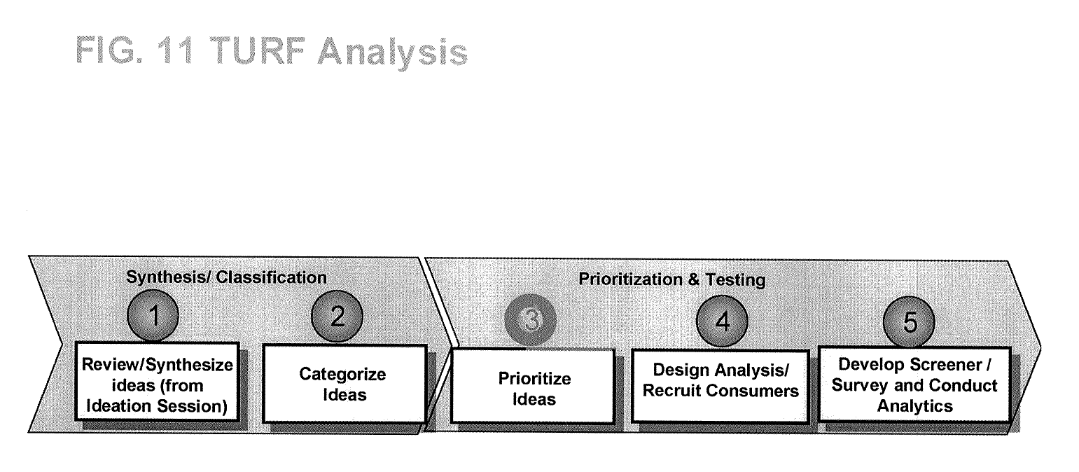

The comprehensive demographic, attitudinal and behavioral insights gained from the multidimensional analysis process 110 enable the development of a robust profile of the targeted consumers. FIG. 9 shows, for example, a detailed profile of representative persona (“Jane”) of the targeted affluent Young Families segment. The detailed profile includes detailed demographic, attitudinal and behavioral characteristics. FIG. 10 summarizes key characteristics of the segment that may be relevant to product card development.

The results of the multidimensional segment analysis process 110 provide a foundation for ideation, feature/benefit development or selection, and product positioning processes (e.g., processes 120-170). For example, the representative persona, Jane, may be used to identify representative consumer panels for consumer leveraging process 120.

As previously noted, consumer leveraging processes 120 can involve consumer ideation processes. In an exemplary implementation of the payment card solutions, a professional facilitator conducts Group Ideation Session Workshops in which creative consumers and a client team generate ideas together in the same room. The workshops involve unique exercises to innovate in different ways, from different perspectives. Consumers and clients participate equally. The clients can act as catalysts for innovation and to ensure successful outcomes. The workshops involve consumers from the “ground up” in product development. Further, the workshops validate consumer needs with an opportunity to contribute ideas. Product development benefits from the creative vision of consumers.

With reference to FIG. 1C, in exemplary implementations of the payment card solutions, quantitative research process 130 may involve “Totally Unduplicated Reach and Frequency” (TURF) analysis. TURF analysis may be conducted using online surveys of a target segment group (See FIG. 11). TURF provides a mathematical approach to optimize bundles of features to arrive at the optimized set of features that will be most attractive to target consumers. TURF can be used to identify the optimal number of features for a card and the specific combinations of features which maximize the “reach” of the card. Further, the technique can be used to measure the potential net impact of offering a particular combination of card features, and to gauge overall consumer appeal.

Although the present invention has been described in connection with specific exemplary embodiments, it should be understood that various changes, substitutions, and alterations apparent to those skilled in the art can be made to the disclosed embodiments without departing from the spirit and scope of the invention.

We claim:

1. A payment card having a bundle of particular features, benefits and functions (collectively “card elements”), wherein the bundle of particular card elements is selected in response to consumer market segment characteristics that are determined by a combination of demographic, attitudinal and behavioral analyses and research.

2. The payment card of claim 1, wherein the bundle of card elements includes card elements that are implemented by a card association.

3. The payment card of claim 1, wherein the bundle of card elements includes card elements that are implemented by a card issuer.

4. The payment card of claim 1, wherein the bundle of particular card elements is further selected in response to consumer market segment characteristics that are determined by consumer research ideation processes.

5. The payment card of claim 1, wherein the demographic analysis for characterization of the consumer market segment comprises life stage analysis.

6. The payment card of claim 1, wherein the behavioral analysis for characterization of the consumer market segment comprises predictive modeling of consumer behavior based on analysis of consumer transaction history.

7. The payment card of claim 1, wherein the combined analyses for characterization of the consumer market segment comprises quantitative research.

8. The payment card of claim 7, wherein the quantitative research comprises Totally Unduplicated Reach and Frequency (TURF) analysis to optimize bundles of card elements in response to consumer market segment characteristics.

9. A method for making a payment card responsive to consumer needs and desires in a consumer market segment, the method comprising:
determining consumer market segment characteristics by a combination of demographic, attitudinal and behavioral analyses and research; and
providing the payment card with a bundle of particular features, benefits and functions (collectively “card elements”), wherein the bundle of particular card elements is selected in response to the consumer market segment characteristics and identified consumer ideation and needs.

10. The method of claim 9, wherein providing the payment card with a bundle of particular card elements comprises providing card elements by a card association.

11. The method of claim 9, wherein providing the payment card with a bundle of particular card elements comprises providing card elements by a card issuer.

12. The method of claim 9, wherein providing the payment card with a bundle of particular card elements comprises selecting card elements in response to consumer market segment characteristics that are determined by consumer research including, ideation processes.

13. The method of claim 9, wherein determining consumer market segment characteristics by a combination of demographic, attitudinal and behavioral analyses and research comprises life stage analysis.

14. The method of claim 9, wherein determining consumer market segment characteristics by a combination of demographic, attitudinal and behavioral analyses and research comprises predictive modeling of consumer behavior based on analysis of consumer transaction history.

15. The method of claim 9, wherein determining consumer market segment characteristics by a combination of demographic, attitudinal and behavioral analyses and research comprises quantitative research.

16. The method of claim 15, wherein determining consumer market segment wherein the quantitative research comprises Totally Unduplicated Reach and Frequency (TURF) analysis to optimize bundles of card elements.
